(19) United States
(12) Patent Application Publication
(10) Pub. No.: US 2014/0201088 A1
(43) Pub. Date: Jul. 17, 2014

(54) Consumer-Centric Product Tracking System

(71) Applicant: Indira Pothuri, Cupertino, CA (US)

(72) Inventor: Indira Pothuri, Cupertino, CA (US)

(21) Appl. No.: 14/155,375

(22) Filed: Jan. 15, 2014

Related U.S. Application Data
(60) Provisional application No. 61/752,964, filed on Jan. 15, 2013.

(51) Int. Cl. G06Q 30/00

(52) U.S. Cl. CPC G06Q 30/012
USPC 705/302

(57) ABSTRACT

In one embodiment, a product tracking system may store product and product related information from multiple commerce chain entities, regardless of where the product purchase occurred. The product tracking server 120 may register a product purchase by a user of a consumer product. The product tracking server 120 may maintain a purchase association between the user and the consumer product separated from a commerce chain. The product tracking server 120 may provide a peripheral product data set to a user device 110 based on the purchase association.

### CROSS-REFERENCE TO RELATED APPLICATIONS

This patent application claim priority from U.S. Provisional Patent Application Ser. No. 61/752,964, filed Jan. 15, 2013, the contents of which are incorporated herein by reference in its entirety.

### BACKGROUND

Purchasing a product may produce a tangible benefit and an intangible benefit for a consumer. A tangible benefit may be the purchase item. The intangible benefit may protect the consumer when the purchase items do not live up to quality expectations, such as the proof of purchase, the warranties, and the manuals.

Tracking these intangible benefits may prove difficult for the consumer, the vendor, the manufacturer, and other members of the chain of commerce. The chain of commerce may include both the producers creating the product being sold, the retailers selling the product, and the consumer buying the product. The consumers may have to track their proof of purchases and warranties. Retailers and manufacturers, due to support calls from consumers, may have to verify product service level agreements.

### SUMMARY

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

Embodiments discussed below relate to a product tracking system may store product and product related information from multiple commerce chain entities, regardless of where the product purchase occurred. The product tracking server may register a product purchase by a user of a consumer product. The product tracking server may maintain a purchase association between the user and the consumer product separated from a commerce chain. The product tracking server may provide a peripheral product data set to a user device based on the purchase association.

### DRAWINGS

In order to describe the manner in which the above-recited and other advantages and features can be obtained, a more particular description is set forth and will be rendered by reference to specific embodiments thereof which are illustrated in the appended drawings. Understanding that these drawings depict only typical embodiments and are not therefore to be considered to be limiting of its scope, implementations will be described and explained with additional specificity and detail through the use of the accompanying drawings.

FIG. 1 illustrates, in a block diagram, one embodiment of a data network.

FIG. 2 illustrates, in a block diagram, one embodiment of a computer.

FIG. 3 illustrates, in a block diagram, one embodiment of a product tracking server architecture.

FIG. 4 illustrates, in a block diagram, one embodiment of a client interface architecture.

FIG. 5 illustrates, in a block diagram, one embodiment of a server-commerce chain interface.

FIG. 6 illustrates, in a flow diagram, one embodiment of a consumer interaction.

FIG. 7 illustrates, in a block diagram, one embodiment of a user interface.

FIG. 8 illustrates, in a flowchart, one embodiment of a method for consumer-centric product tracking with a product tracking server.

FIG. 9 illustrates, in a flowchart, one embodiment of a method for providing a peripheral product data set with a product tracking server.

FIG. 10 illustrates, in a flowchart, one embodiment of a method for tracking a warranty agreement with a product tracking server.

FIG. 11 illustrates, in a flowchart, one embodiment of a method for accessing a product tracking server with a user device.

### DETAILED DESCRIPTION

Embodiments are discussed in detail below. While specific implementations are discussed, it should be understood that this is done for illustration purposes only. A person skilled in the relevant art will recognize that other components and configurations may be used without parting from the spirit and scope of the subject matter of this disclosure. The implementations may be a machine-implemented method, a tangible machine-readable storage medium having a set of instructions detailing a method stored thereon for at least one processor, or a product tracking system.

A consumer-centric product tracking system may improve the consumer experience by providing aftermarket support for products to enhance the lifetime experience of a purchased product and provide convenient service interface for claims under warranty. The consumer-centric product tracking system may guide the user through the purchase process by offering reviews of the product prior to purchase. The consumer may use the product tracking system to poll other consumers via social media. The consumer-centric product tracking system may alert the user to any pricing changes or price matching offers. The consumer-centric product tracking system may streamline warranty management from a consumer's perspective, allowing a consumer to consolidate peripheral information, such as warranties and manuals, for a product in a single virtual location regardless of the business entities associated with that product. A product tracking system may simplify the consumer experience to store and retrieve product information, such as product upgrades, additional accessories, warranty renewals, rebates, and notifications to enhance the lifetime experience.

A consumer-centric approach gathers purchase information around a user, regardless of the manufacturer or retailer of the product. A consumer-centric approach may aggregate warranty service for each product owned by the customer, collecting data normally inaccessible to an individual business entity in the commerce chain or the warranty chain. Additionally, the consumer-centric approach may facilitate any technical support queries the consumer may have for a product. Thus the product information is stored based on the consumer, aggregating the warranty and other services associated with a product in a consumer-centric application platform. The product information may be stored in a centralized cloud server to allow ready access to any user device.

Further, the consumer-centric product tracking system may open new sales opportunities to members of the commerce chain, while increasing brand loyalty in the consumer. The commerce chain is the manufacturers and retailers that produce and sell a product, from original part creation to delivering the product into the hands of the user. The product tracking system may allow any business in the production, retail, or service of a product to maintain a relationship with the customer. The product tracking system may bridge the business back to these costumers through a cloud service that enables proactive warranty and other product and service offerings. In the current consumer to business market, a consumer may have various options for purchase management on a smart-phone or via the web on a computer. Warranty accessibility and after purchase service expectations may be explored by comparative shopping, social networking, and mobile applications. A product tracking system may raise the bar for trading partners—retailers, manufacturers, and original equipment manufacturers to provide a source of competitive advantage to consumer relationship management while reducing costs and increasing revenues. The product tracking systems may allow participants to determine current process gaps that are causing low customer satisfaction, bring consumers and trading partners in the warranty chain closer, assist consumers with convenience in purchasing decisions, and assist trading partners with low costs and increased revenues. The product tracking system may provide an effective channel for providing accessories and service agreements related to the products to the consumer to enhance the lifetime experience of the product.

Today, consumers may access vast amounts of data through social media, in addition to the traditional media. With the smart phone explosion, this data may instantaneously guide consumers in making purchasing decisions. Consumers may use many available avenues to research products and peripheral product data, causing lifestyle changes that affect product purchase decisions and product warranty purchase decisions.

Over the last few years, due to the introduction of social networking, smart phones, and smart phone applications, information access may be readily available in many facets of life, including warranties. These technologies may improve convenience and cost effectiveness for consumers. These technology advancements may increase consumer expectations of the same level of service after purchasing products. Consumers may expect first time resolution, repair, and replacement without pain, improving the quality of service from the point of sale to throughout products' warranty life either under warranty or extended service plan. A consumer making a purchase may consider the critical factors of the cost of ownership, the convenience of the transaction, and the after purchase support. The in-store or online experience of the transaction may influence consumer purchasing decisions.

The consumer-to-business models and comparative shopping technology landscape may change consumer perspective on pricing and pre-purchase research. Consumer spending may move to better pricing with reduced loyalty to one store or one brand of products. Consumer behavior may apply to both products and product warranties. Consumers may use the internet to research prices for product purchases and extended warranty purchases.

If a company is unable to live up to pricing and quality of service expectations, poor warranty sales and poor warranty service management may significantly hurt a company's bottom line. The biggest challenges for the businesses in the warranty space may be providing first time resolution, reducing costs by detecting fraudulent warranty claims, taking into account the price of the product, cost of service, cost of extended warranty, and increasing warranty sales. An efficient front-line customer support may facilitate securing customer retention. To add to these challenges, the negative connotations of extended service contracts, social media, and comparative shopping influence on consumer behavior may affect warranty sales.

Conservative business processes may cause many companies to not adapt to new technology quickly. For example, many companies may use paper manuals, warranties, receipts, and product registrations. While some businesses have adapted technologies such as in-store marketing, location-based-advertising, and social TV to market the products, some companies may still use telemarketers making cold calls to sell extended warranty service plans. Many consumers may make numerous service calls to resolve a simple issue covered under warranty. These processes may be very expensive for a company's bottom-line. Mobile commerce may expand opportunities in warranty management and warranty sales for businesses.

Understanding consumer lifestyle and behavior may be used to bridge the gaps in the warranty chain management, to improve warranty sales and warranty service experience cost effectively. The technology influence on consumer behavior towards extended warranty purchases may be more psychological than economical. A consumer's decision-making process may depend on affect, behavior, and cognition induced belief. The affect refers to the feelings that consumers develop when they become aware of a products' existence either through traditional media and advertising or through latest technologies such as the social media or product reviews. The behavior refers to the product purchase and the cognition or the belief represents the product's impression that consumer develops after the purchase. If a consumer's purchase is a sequence of affect, behavior, and cognition, the consumer may have a higher level involvement with those products. This may imply higher consumer satisfaction with the purchase leading to future loyalty to the manufacturers and retailers. If the warranty sales happen at the point of sale, the sequence may instead be behavior, affect, and belief. This sequence may produce a lower involvement with the product warranty purchases, leading to less customer satisfaction and high warranty service expectations. Additionally, the service expectations thereafter may influence future purchase decision of extended warranties for similar products or products of the same brand.

A product tracking system may change consumer behavior towards extended warranty sales by following the same paradigm as the product itself for buying an extended warranty, using affect, behavior, and cognition. Instead of a high-pressure sales pitch from the sales person or cashier at the register, the product tracking system may give the consumer an opportunity to learn about the extended warranty in a presentation similar to the product, even after the point of purchase. The process may lead to high cognition, and thus higher involvement with extended warranty purchases.

In addition to providing options to buy extended warranty at a later point, the product tracking system may provide easy accessibility to the customer support number, product registration, product maintenance help, and do it yourself videos readily available in a central place associated with a product to improve consumer satisfaction and brand loyalty.

A mobile commerce platform implementing a product tracking system may fill gaps in the warranty chain to increase the chances of positive consumer experience in after sale service. This mobile commerce platform may also bring trading partners closer to the consumers at the same time. An effective claims submission process and real-time status lookup of a claim built into the system may give consumers a better after sale experience leading to brand loyalty. This mobile commerce platform may provide easy access to service level agreement information and claim history to reduce fraudulent warranty claims for the businesses and save costs in the warranty chain. Reducing pressure at the time of sale and providing an option to buy a warranty at a later point from the retailer, manufacturer, or the third party cost effectively may change the high-pressure sales perspective of non-risk-averse consumers' attitude towards extended service contracts. Staying connected to the consumer even after point of sale and offering service level agreement as a binding force may provide a win-win situation for consumers and trading partners.

Today, businesses that sell extended service contracts may contend with putting pressure on the consumer at the time of sale and reinstating contact with the consumer. Instead, if companies focus on holding onto the customer after sale by providing a mechanism to be in touch with their customers to serve them better during the products' life cycle may funnel the new opportunities to not only sell extended warranties but also other products. The mobile commerce platform may easily build brand loyalty through positive consumer experience.

The product tracking system may solve the problem of connecting retailers to consumer after sale of goods by providing access to product information, such as warranties and service level agreements. The product tracking system may help consumers to maintain products during the life cycle by providing proof of purchases and warranty information. The product tracking system may track products owned, as well as proof of purchase, service level agreements, warranties, manuals, do it yourself (DIY) help, and ancillary service products. The product tracking system may provide commerce chain entities with a platform to offer sale of extended service contracts and warranties and renewal of service contracts and warranties. A commerce chain entity is any member of the commerce chain or warranty chain. The commerce chain describes the entities from the manufacture to the retailer. The warranty chain describes any provider of after sale services or products. An extended service contracts protects a product with standard maintenance services, such as an oil change for an automobile. A warranty protects the consumer from any faulty merchandise over a given period of time. Additionally, the product tracking system may provide product support help, manuals, do-it-yourself instructions, and other data at less cost.

The product tracking system allows the retailer, the manufacturer, or any other member of the commerce chain or warranty chain to provide further services to the consumer. The product tracking system may fill the process gaps in providing service information for product maintenance after the point of sale while giving business opportunities for commerce chain entities to better serve consumers, improving consumer satisfaction and providing revenue by increasing warranty sales. The commerce chain entities may use the product tracking system to send to the consumer notifications of available support services, upgrades to support services, or new support services. For example, the commerce chain entity may use the product tracking system to send to the consumer product recalls, price changes, and a warranty expiration notifications or to receive submitted rebate forms and product registrations.

The product tracking system may be implemented as a software as a service (SAAS) platform with multi-tenant client-server architecture. The product tracking system may use server and mobile or web client components to provide interaction between commerce chain entities and consumers.

The product tracking system may include a calculator with a comparative warranty algorithm to compare warranty costs between multiple warranties. The multiple warranties may be for the same product or for a group of products owned by the consumer. The multiple warranties may be from the same commerce chain entity or multiple chain entities.

The product tracking system may provide an administrative portal for commerce chain members to maintain their branding needs, such as white label information; maintain configuration settings to interact with their backend systems that maintain inventory and sale of warranties; generate receipts; and push into product tracking servers. The administrative portal also may provide commerce chain administrative user account management. The product tracking system may provide a partner portal for a point of sale vendor configuration to get product purchase information at the time of sale. The product tracking system may provide a consumer portal for consumers to create user accounts, access product information, purchase warranties, and access product maintenance help such as manuals, DIY videos/help, receipts, and other support services.

The product tracking system may offer a mobile application for consumers to download for different platforms, such as iOS, Android, and Windows Mobile.

The product tracking system servers may provide a functionality to support through a web or mobile application independent of the chain of commerce. A consumer may use the application to track the products owned, the corresponding receipts, warranty expiration notifications and rebate submissions.

The product tracking system may provide multiple application programming interfaces (APIs) to interact with the client software, both web and mobile. The product tracking system application programming interfaces may receive information posted from external entities such as POS and retail systems.

The product tracking system may work with both electronic receipts and paper receipts. The product tracking system may read these receipts directly from point of sale systems, near field communication (NFC) Systems, or using optical character recognition (OCR). The product tracking system may maintain an e-mail inbox, so that a consumer or other entity may forward receipts from a regular email account to the product tracking system to link a receipt to a product purchase. The product tracking system may extract the purchase information from an e-mail describing the purchase. Alternately, a consumer may use a smart phone to scan a universal product code (UPC) or a quick response (QR) code representing a product related data set to store the purchase information using a one-click input.

The product tracking system may connect consumers with owners of similar products for service help based on reviews. The product tracking system may also connect consumers with service technician network who were able to fix similar products.

The product tracking system may incorporate a number of features to create convenient user experience. The client login may be a proprietary account or may be integrated with existing social networks, such as Facebook® or Google+®. The client interface may allow the user to create, delete or modify a user account, with contingencies in place to protect the user that forgets a password or user identifier.

A product tracking database may store a product record having multiple fields. A product inventory field may identify the product, using a name, description, universal product code (UPC), quick response (QR) code, global trade item number (GTIN), make, or model. The warranty field may describe a warranty type. A vendor field may describe vendor identifier for the product. A product tracking database may store a user record. The user record may indicate products owned by the user, user receipts, and products purchased from a specific vendor.

The product tracking system may have an application programming interface that performs a number of operations, such as create, retrieve, update, share with others, and delete. The retailer or vendor may post a receipt to the product tracking server from the point of sale. The product tracking system may forward that receipt to a user e-mail account. The product tracking system may associate warranty information and other product information to a user, a stock keeping unit, a product identifier, or other data. Warranty information may include commencement date, expiration date, type of warranty, and other data. The retailer or the vendor may direct an extended warranty sale, warranty change notification, recall, or other data to the consumers of the product.

Thus, the user may receive a receipt, manuals, do-it-yourself installation videos, warranty documents, actual manufacturer warranty expiration date, notifications at key points in life cycle to extend warranties, and an option to extend warranty. The receipt may be uploaded from the point of sale. Alternately, the user may photograph or scan the receipt and upload the image to the product tracking system. The option to extend the warranty may be a message directing a user to a website offering the sale.

The product tracking system may create a temporary record until claimed by a non-subscribed user. The retailer or vendor may push the receipt information to the product tracking system. From the receipt, based on either the universal product code (UPC), quick response (QR) code, or product identifier, the product tracking database may locate the manufacturer warranty and manuals. If the information is not already present, the product tracking system may retrieve the data from the manufacturer or retailer website, either in the form of a link or the actual documents. The retailer may push a service tag number into the product tracking database. Alternately, the user may input the service tag number. Independent of the retailer or vendor, the consumer may scan the universal product code on the product and import a receipt manually and track the purchased products.

Thus, a product tracking system may store product and product related information from multiple commerce chain entities, regardless of where the product purchase occurred. The product tracking server may register a product purchase by a user of a consumer product. The product tracking server may maintain a purchase association between the user and the consumer product separated from a commerce chain. The product tracking server may provide a peripheral product data set to a user device based on the purchase association. The peripheral product data set may be a product manual, a proof of purchase, a product related communication, or a warranty agreement.

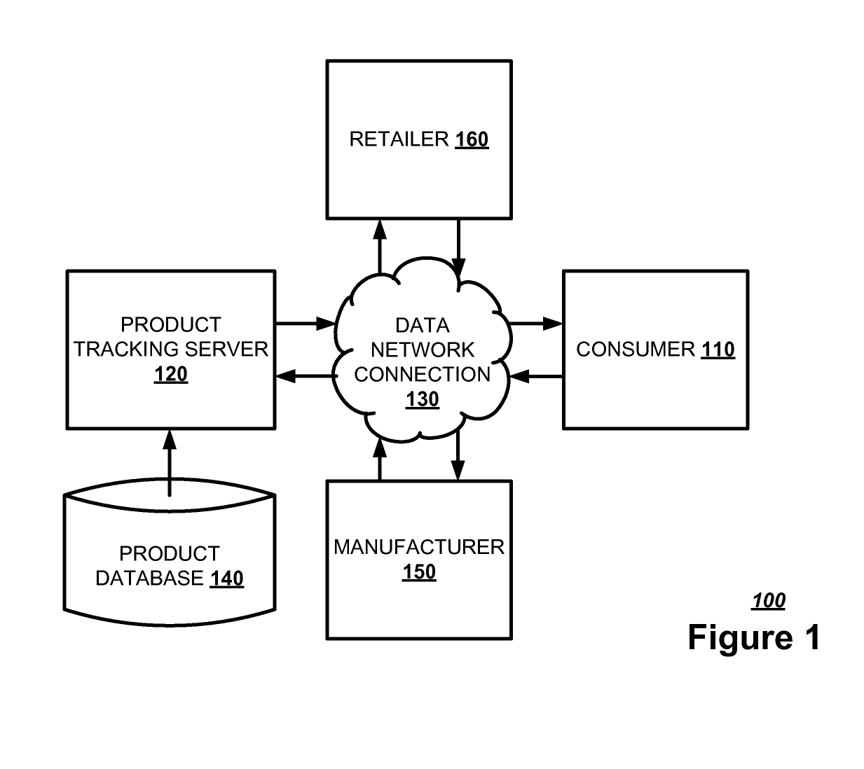

FIG. 1 illustrates, in a block diagram, one embodiment of a data network 100. A consumer using a user device 110 may connect to a product tracking server 120 via a data network connection 130, such as the internet. The product tracking server may maintain a product tracking database 140 that contains a product identifier associated with a set of product support data, such as warranties, manuals, and other information. A manufacturer 150 may populate the product tracking database before placing the product on the market or once a consumer has registered purchasing the product. A retailer or vendor 160 may notify the product tracking database upon purchase of the product by the consumer.

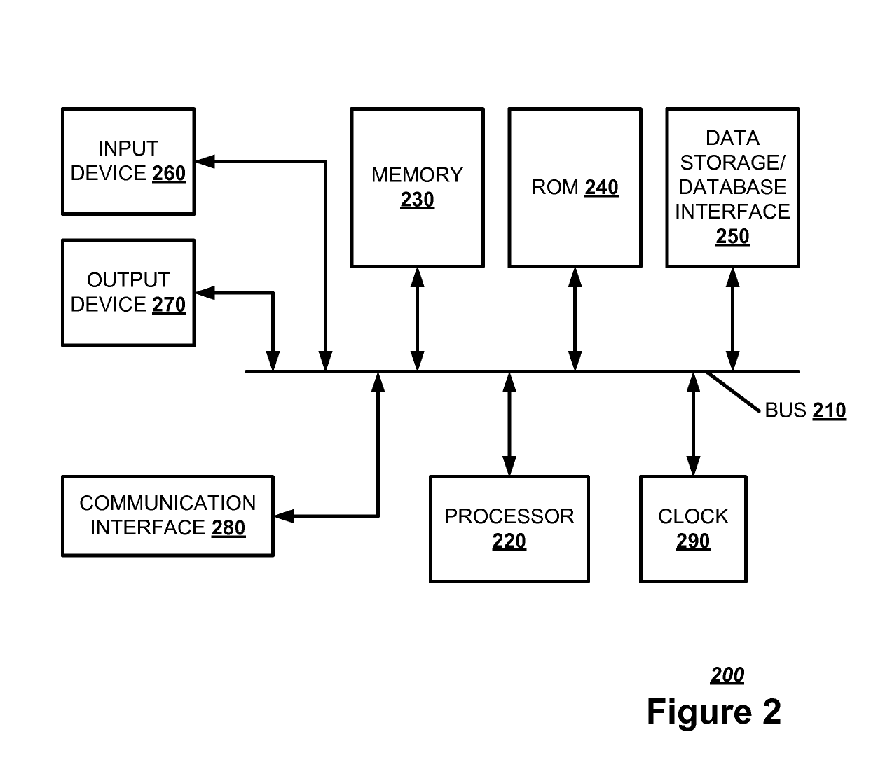

FIG. 2 illustrates a block diagram of an exemplary computing device 200 which may act as a product tracking system. The computing device 200 may combine one or more of hardware, software, firmware, and system-on-a-chip technology to implement a product tracking system. The computing device 200 may include a bus 210, a processor 220, a memory 230, a data storage 240, a database interface 250, an input device 260, an output device 270, and a communication interface 280. The bus 210, or other component interconnection, may permit communication among the components of the computing device 200.

The processor 220 may include at least one conventional processor or microprocessor that interprets and executes a set of instructions. The memory 230 may be a random access memory (RAM) or another type of dynamic data storage that stores information and instructions for execution by the processor 220. The memory 230 may also store temporary variables or other intermediate information used during execution of instructions by the processor 220. The data storage 240 may include a conventional ROM device or another type of static data storage that stores static information and instructions for the processor 220. The data storage 240 may include any type of tangible machine-readable storage medium, such as, for example, magnetic or optical recording media, such as a digital video disk, and its corresponding drive. A tangible machine-readable storage medium is a physical medium storing machine-readable code or instructions, as opposed to a signal that propagates machine-readable code or instructions. Having instructions stored on computer-readable media as described herein is distinguishable from having instructions propagated or transmitted, as the propagation transfers the instructions, versus stores the instructions such as can occur with a computer-readable medium having instructions stored thereon. Therefore, unless otherwise noted, references to computer-readable storage media/medium having instructions stored thereon, in this or an analogous form, references tangible media on which data may be stored or retained. The data storage 240 may store a set of instructions detailing a method that when executed by one or more processors cause the one or more processors to perform the method. A database interface 250 may connect to a database for storing product data, product ancillary service data, and consumer data.

The input device 260 may include one or more conventional mechanisms that permit a user to input information to the computing device 200, such as a keyboard, a mouse, a voice recognition device, a microphone, a headset, a gesture recognition device, a touch screen, etc. The output device 270 may include one or more conventional mechanisms that output information to the user, including a display, a printer, one or more speakers, a headset, or a medium, such as a memory, or a magnetic or optical disk and a corresponding disk drive. The communication interface 280 may include any transceiver-like mechanism that enables computing device 200 to communicate with other devices or networks. The communication interface 280 may include a network interface or a transceiver interface. The communication interface 280 may be a wireless, wired, or optical interface.

The computing device 200 may perform such functions in response to processor 220 executing sequences of instructions contained in a computer-readable medium, such as, for example, the memory 230, a magnetic disk, or an optical disk. Such instructions may be read into the memory 230 from another computer-readable medium, such as the data storage 240, or from a separate device via the communication interface 280.

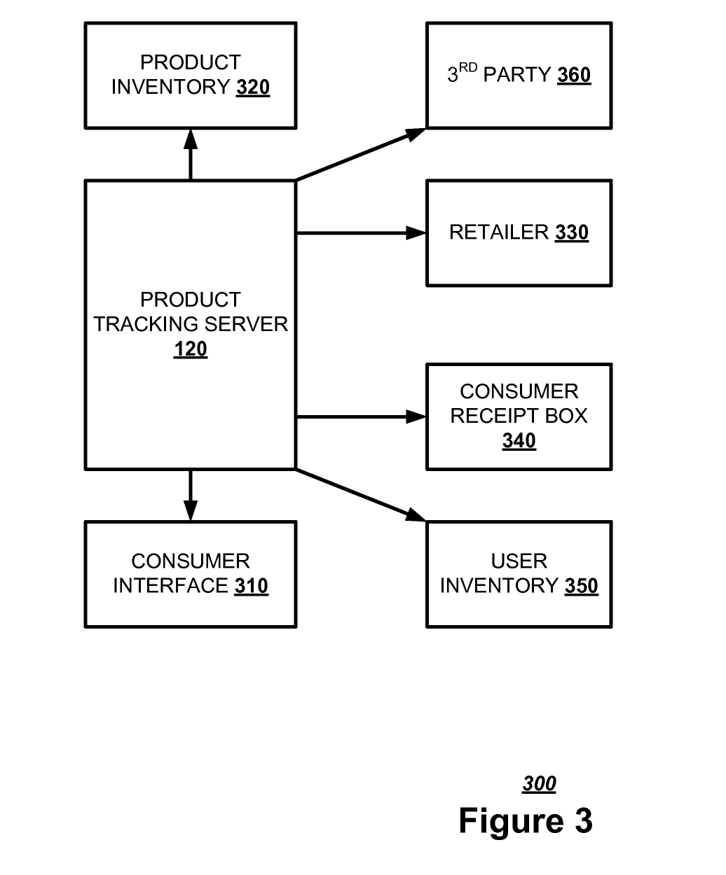

FIG. 3 illustrates, in a block diagram, one embodiment of a product tracking server architecture 300. A product tracking server 120 may connect a consumer interface 310, such as an application programming interface or data integration, to available product information sources. The product tracking server 120 may access a product inventory 320 listing the various products tracked by the product tracking service. The product tracking server 120 may access a retailer application programming interface or data integration 330 for information stored by the retailer.

The product tracking server 120 may maintain a consumer receipt box 340 to store receipt information for purchases of a consumer. The consumer receipt box 340 may store an electronic receipt sent by the retailer or vendor to a linked user account. The linked user account may be a user account maintained by the product tracking server 120 or an external account that has granted access to the product tracking server 120. A user account may be an e-mail account, short messaging service account, a social network account, or other communication account. A user may also upload a scanned copy of a paper receipt to the consumer receipt box 340 after purchase. The product tracking server 120 may use the consumer receipt box to track user purchases, as well as for proof of purchase.

The product tracking server 120 may maintain a user inventory 350 tracking the purchases and the associated peripheral product data sets for the consumer. The product tracking server 120 may access a third party application programming interface or data integration 360 to acquire any data stored by a third party.

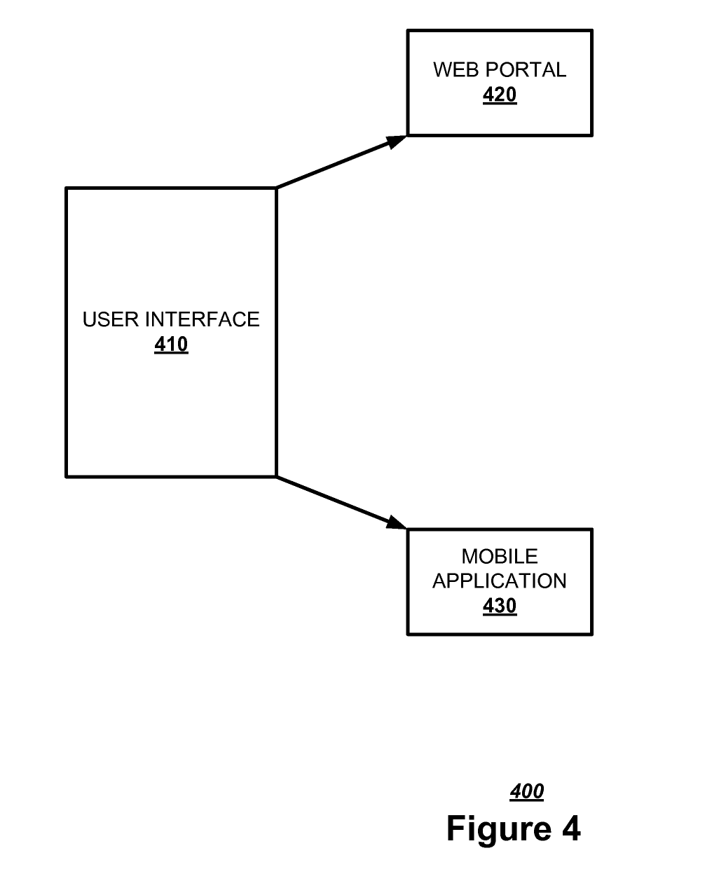

FIG. 4 illustrates, in a block diagram, one embodiment of a client interface architecture 400. The client interface architecture 400 may connect the user device 110 to the product tracking server 120 via the data network connection 130. A user interface 410 may be instantiated as a web portal 420 or a mobile application 430. A web portal 420 may allow the user to access the product tracking server 120 via an internet browser. A mobile application 430 is an application resident on a smart phone, tablet, laptop, or desktop computer dedicated to accessing the product tracking server 120.

Upon purchase at a point of sale, notifications of that sale may be forwarded to the product tracking system. The product tracking system may connect a new purchase to product related data already in the system. If no data is present in the system, product tracking system may search various resources, such as a retailer database, a manufacturer database, or a third party database to find data related to that product.

A consumer may scan a receipt or a bar code associated with a product. The consumer may then link the receipt to the product in the product tracking system. The consumer may forward an e-mail receipt to the product tracking system. The product tracking system may then link the e-mail receipt and product to the user. A consumer may log in to a product tracking server to upload recent purchase information. The consumer may then download from the product tracking server information related to that product.

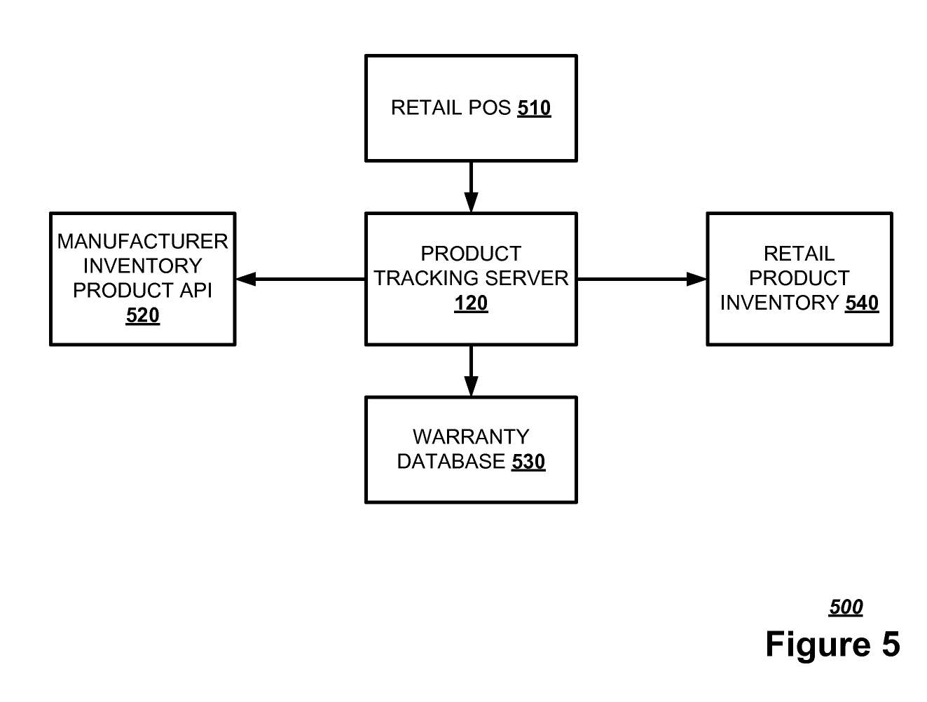

FIG. 5 illustrates, in a block diagram, one embodiment of a server-commerce chain interface 500. The product tracking server 120 may receive notice of a purchase from a retail point of sale 510. The product tracking server 120 may search the manufacturer database via a manufacturer inventory product application programming interface 520 for manufacturing based peripheral product data. The product tracking server 120 may search a warranty database 530 for warranties related to the product purchased. The product tracking server 120 may search a retail product inventory database 540 for retailer based peripheral product data.

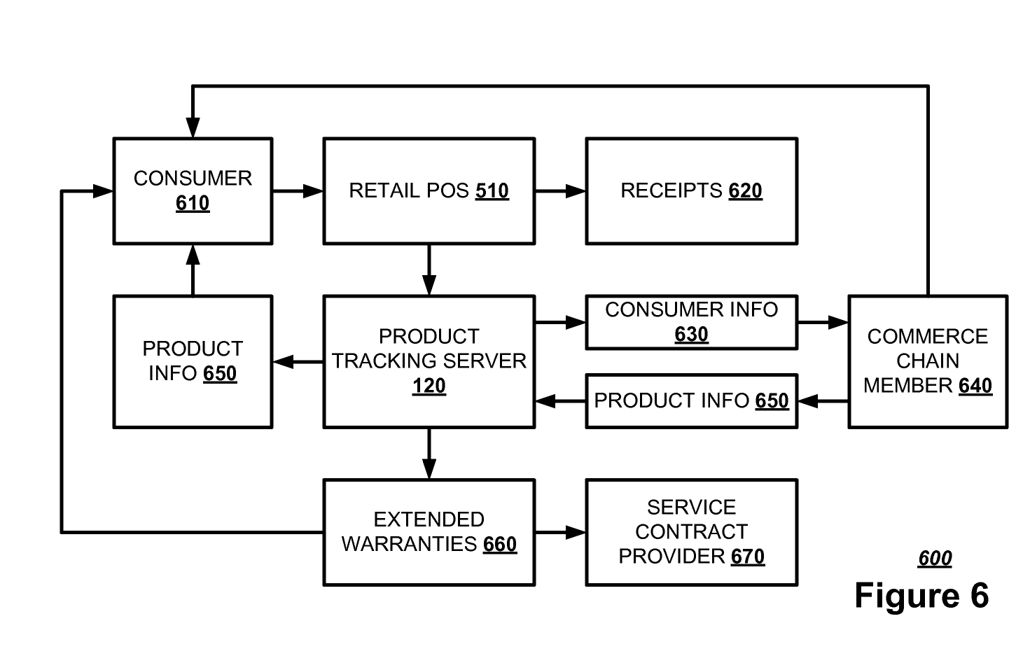

FIG. 6 illustrates, in a flow diagram, one embodiment of a consumer interaction 600. A consumer 610 may purchase a product at a retail point of sale 510. The product tracking server 120 may assign a consumer identifier to the consumer 610. The retail point of sale 510 may produce a receipt 620 at the purchase, such as a paper receipt, an electronic receipt or a short messaging service text. The consumer 610 may provide consumer information 630 to identify the consumer 610 to the retail or vendor point of sale 510, which forwards the consumer information 630 on to the product tracking server 120. The consumer information 630 may be a user name, an identifying portion of a credit card number, a purchase date, a retailer identifier, or other identifying information. The product tracking server 120 may later use this consumer information 630 to associate the consumer 610 with each product purchased.

The product tracking server 120 may then forward the consumer information 630 on to one or more commerce chain members 640, such as a manufacturer or a retailer. The commerce chain member 640 may return product information 650 regarding the purchase on to the product tracking server 120, such as a product manuals or product upgrades. One of the commerce chain members 640 may provide an associated product offering to the consumer 610 based on consumer purchasing behavior. A product upgrade may be a patch, a hack, a product fix, accessories, or add-ons. The product tracking server 120 may the forward that product information 650 to the consumer 610.

The product tracking server 120 may then provide notice of any extended warranties 660 purchased by the consumer 610 to a service contract provider 670. The service contract provider may offer a warranty, extended warranty, or other purchase protection. The product tracking server 120 may then provide those extended warranties 660 to the consumer 610. The product tracking server 120 may maintain the service contract, submit claims, and, where allowed by partnership agreement, provide access to claim status.

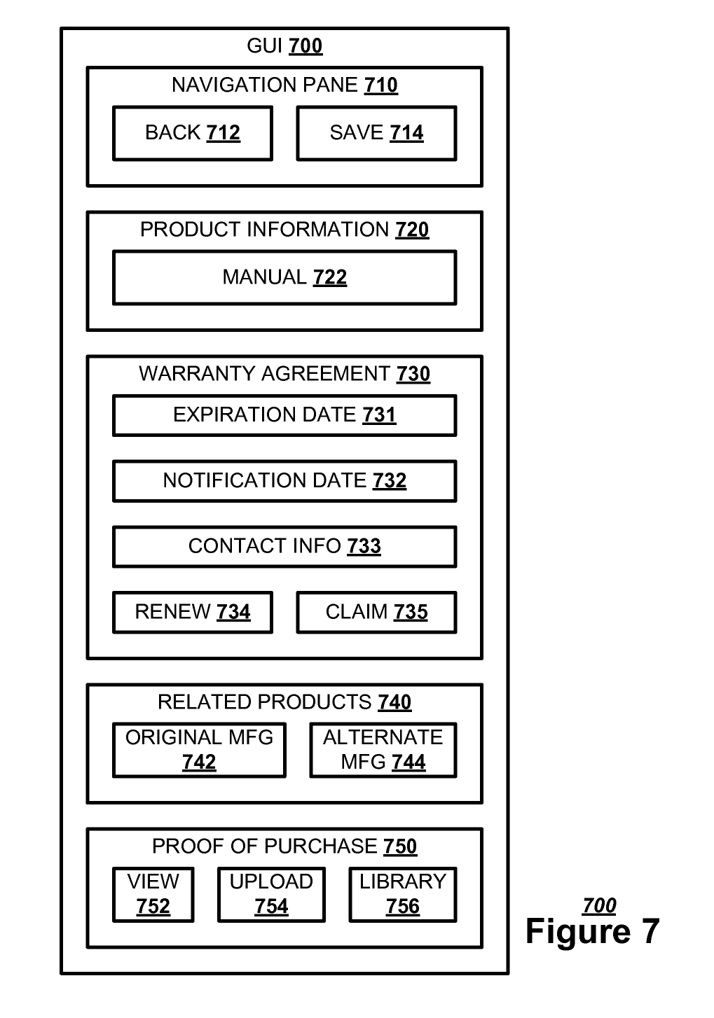

FIG. 7 illustrates, in a block diagram, one embodiment of a graphical user interface 700. The graphical user interface 700 may be customized based on the commerce chain entity. The graphical user interface 700 may have a navigation pane 710 to move between different data presentations. The navigation pane 710 may have a back button 712 to return to an earlier data presentations, and a save button 714 to save a current data presentation. A product information pane 720 may display a set of peripheral product data, such as a product manual 722 for a recently purchased product. A warranty agreement pane 730 may allow a user to read or enter warranty data, such as an expiration date 731, a notification date 732 for alerting a consumer that a warranty is expiring, and a contact information field 733 for contacting a consumer. A warranty agreement pane 730 may have one or more one-click buttons, such as a renew button 734 to allow the consumer to renew the warranty and a claim button 735 to allow the user to make a warranty claim. A related products pane 740 may provide products available to purchase that are related to the initial purchase. A related product may be an accessory or other item that improves the lifetime experience of the purchased product. The related products may be products available from original manufacturer 742 or from an alternate manufacturer 744. A proof of purchase pane 750 may allow a user to access proof of purchase information, such as receipts. The proof of purchase pane 750 may have a view button 752 to seek to view a proof of purchase, an upload button 754 to initiate the upload of a scanned receipt, and a library button 756 to retrieve a proof of purchase information from an online library.

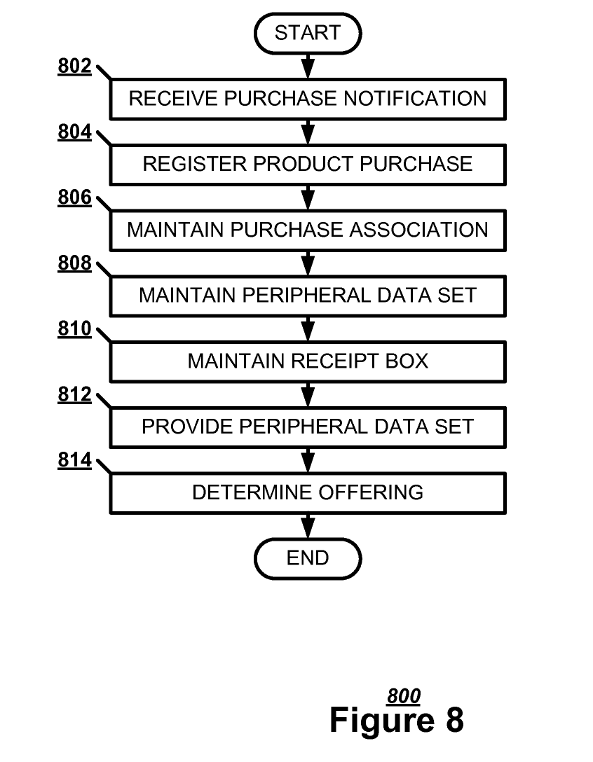

FIG. 8 illustrates, in a flowchart, one embodiment of a method 800 for consumer-centric product tracking with a product tracking server. The product tracking server 120 may receive a purchase notification from at least one of a user device 110, a retailer point of sale 160, a manufacturer server 150, or a linked user account (Block 802). A manufacturer server 150 may be a manufacturer point of sale or product registry tracking database. A linked user account may be a user account, such as an e-mail account, maintained by the product tracking server 120. Alternately, a linked user account may be a user account, such as e-mail or social network, maintained by an external service but accessible by the product tracking server 120. The product tracking server 120 may register a product purchase by a user of a consumer product (Block 804). The product tracking server 120 may maintain a purchase association between the user and the consumer product separated from a commerce chain (Block 806). The product tracking server 120 may maintain a peripheral product data set associated with the consumer product (Block 808). The product tracking server 120 may maintain a consumer receipt box 340 managing consumer purchases (Block 810). The consumer receipt box 340 may be a set of digital receipts or represent of actual paper receipts. The product tracking server 120 may provide the peripheral product data set to a user device based on the purchase association (Block 812). The product tracking server 120 may determine at least one of a service offering and a product offering based on a consumer purchase history (Block 814). A service offering may be an extended warranty or product updates or fixes. A product offering may be an associated product that may be purchased in conjunction with the original product purchase.

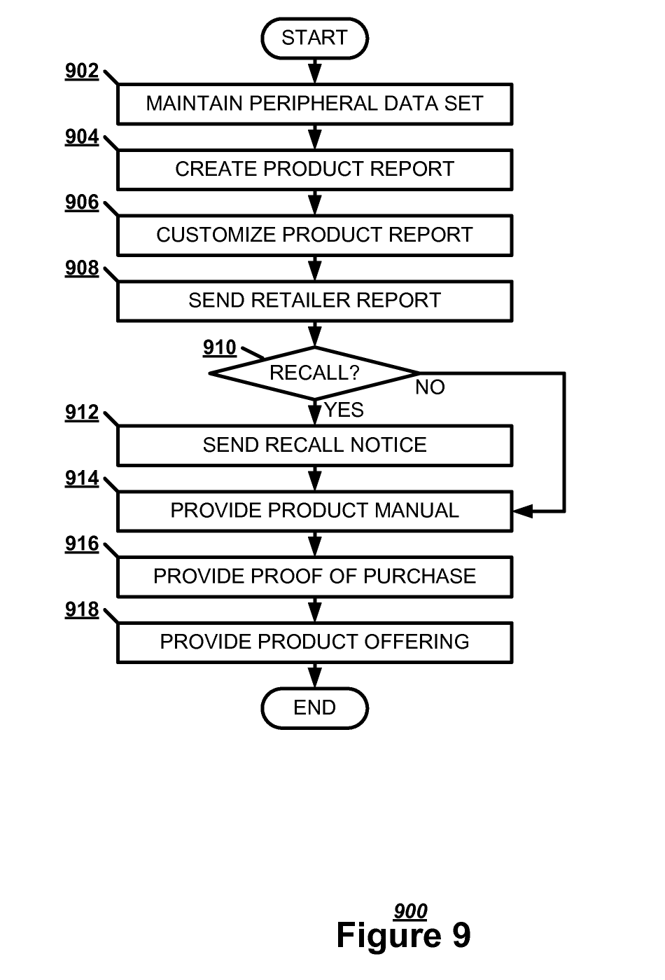

FIG. 9 illustrates, in a flowchart, one embodiment of a method 900 for providing a peripheral product data set with a product tracking server 120. The product tracking server 120 may maintain a peripheral product data set associated with the consumer product (Block 902). The peripheral product data set may be a product manual, a proof of purchase, a product related communication, a warranty agreement, or other data not directly a part of the original product. The product tracking server 120 may create a product report for a commerce chain member 630 (Block 904). A retailer-centric product report may describe product usage metric, product lifetime experience statistics, product quality and consumer satisfaction metrics, consumer purchase behavior, and preferences data. The product tracking server 120 may customize the product report based on the commerce chain member 630 receiving the product report, such as a retailer or a manufacturer (Block 906). The product tracking server 120 may send the product report to the commerce chain member 630 (Block 908). If a commerce chain member initiates a recall (Block 910), the product tracking server 120 may send a recall notice to a user device 110 (Block 912). The product tracking server 120 may provide a product manual 722 for a consumer product to a user device 110 (Block 914). The product tracking server 120 may provide a proof of purchase for a product to a user device 110 upon request (Block 916). The product tracking server 120 may provide associated product offerings and extended warranties to the consumer 610 in a product related communication (Block 918).

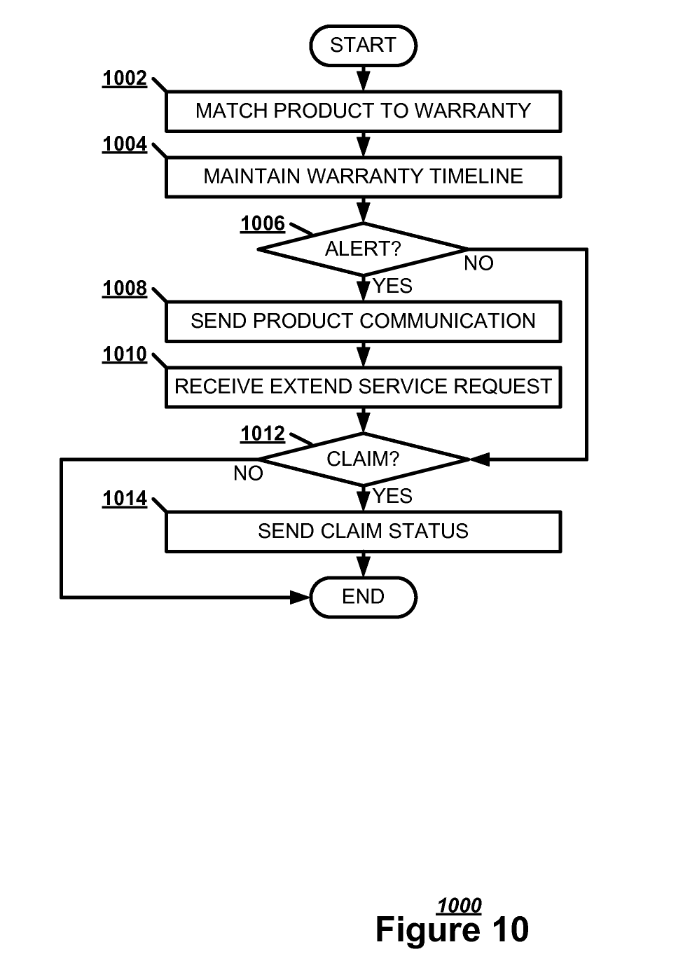

FIG. 10 illustrates, in a flowchart, one embodiment of a method 1000 for tracking a warranty agreement with a product tracking server 120. The product tracking server 120 may match the consumer product to a product warranty (Block 1002). The product tracking server 120 may maintain a warranty timeline for the consumer product (Block 1004). If an alert period is set to occur (Block 1006), the product tracking server 120 may send a product communication to the user device 110 within the alert period (Block 1008). A product communication may be any product related message, such as a warranty expiration alert, a complementary product offer, recall notice, or other product information. The product tracking server 120 may receive an extended service contract request from the user device 110 (Block 1010). If the product tracking server 120 receives a warranty claim via a one-click request from a user device 110 (Block 1012), the product tracking server 120 may send a warranty claim status to a user device 110 (Block 1014).

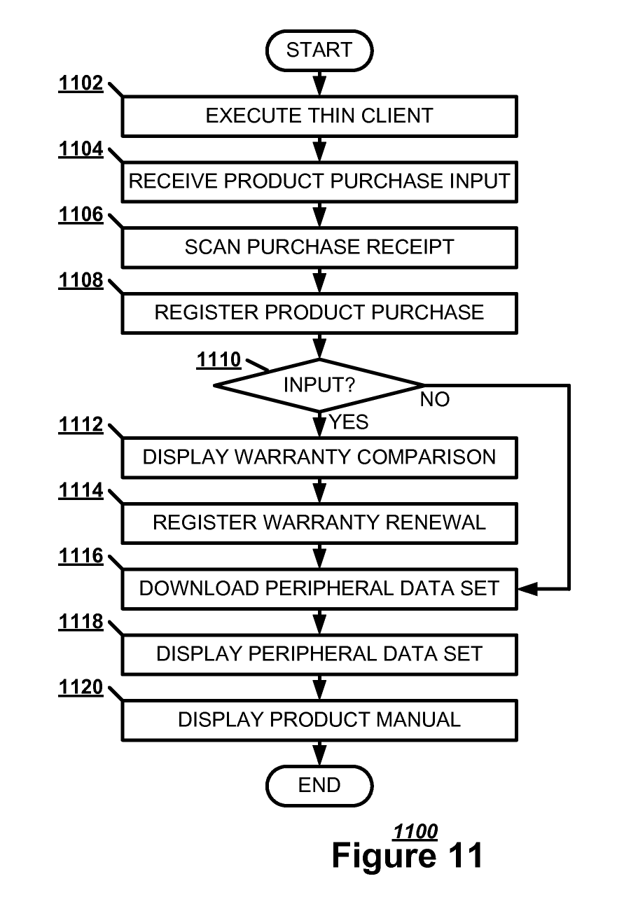

FIG. 11 illustrates, in a flowchart, one embodiment of a method 1100 for accessing a product tracking server 120 with a user device 110. The user device 110 may execute a thin client to interact with the product tracking server 120 (Block 1102). The user device 110 may receive a user input of a product purchase to register the product purchase (Block 1104). The user device 110 may scan a purchase receipt to register the product purchase (Block 1106). The user device 110 may register a product purchase by a user of a consumer product with a consumer-centric product tracking system separated from a commerce chain to create a purchase association between the user and the consumer product (Block 1108). If the user device 110 receives a one-click input from the user (Block 1110), the user device 110 may display a warranty comparison for the consumer product to the user (Block 1112). The warranty comparison may include both price and terms for the warranty. The user device 110 may register a warranty renewal with a commerce chain member 640 (Block 1114). The user device 110 may download a peripheral product data set based on the purchase association (Block 1116). The user device 110 may execute the thin client application to display the peripheral product data set (Block 1118). The user device 110 may display a product manual 722 for the consumer product to a user (Block 1120).

Although the subject matter has been described in language specific to structural features and/or methodological acts, it is to be understood that the subject matter in the appended claims is not necessarily limited to the specific features or acts described above. Rather, the specific features and acts described above are disclosed as example forms for implementing the claims.

Embodiments within the scope of the present invention may also include computer-readable storage media for carrying or having computer-executable instructions or data structures stored thereon. Such computer-readable storage media may be any available media that can be accessed by a general purpose or special purpose computer. By way of example, and not limitation, such computer-readable storage media can comprise RAM, ROM, EEPROM, CD-ROM or other optical disk storage, magnetic disk storage or other magnetic data storages, or any other medium which can be used to carry or store desired program code means in the form of computer-executable instructions or data structures. Combinations of the above should also be included within the scope of the computer-readable storage media.

Embodiments may also be practiced in distributed computing environments where tasks are performed by local and remote processing devices that are linked (either by hardwired links, wireless links, or by a combination thereof) through a communications network.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Although the above description may contain specific details, they should not be construed as limiting the claims in any way. Other configurations of the described embodiments are part of the scope of the disclosure. For example, the principles of the disclosure may be applied to each individual user where each user may individually deploy such a system. This enables each user to utilize the benefits of the disclosure even if any one of a large number of possible applications do not use the functionality described herein. Multiple instances of electronic devices each may process the content in various possible ways. Implementations are not necessarily in one system used by all end users. Accordingly, the appended claims and their legal equivalents should only define the invention, rather than any specific examples given.

We claim:

1. A machine-implemented method, comprising:
registering a product purchase by a user of a consumer product;
maintaining a purchase association between the user and the consumer product separated from a commerce chain; and
providing a peripheral product data set to a user device based on the purchase association.

2. The method of claim 1, further comprising:
receiving a purchase notification from at least one of a user device, a retailer point of sale, a manufacturer server, and a linked user account.

3. The method of claim 1, further comprising:
determining at least one of a service offering and a product offering based on a consumer purchase history.

4. The method of claim 1, further comprising:
maintaining a consumer receipt box managing consumer purchases.

5. The method of claim 1, further comprising:
matching the consumer product to a product warranty.

6. The method of claim 1, further comprising:
maintaining a warranty timeline for the consumer product.

7. The method of claim 1, further comprising:
receiving at least one of an extended service contract request and a warranty claim from a user device.

8. The method of claim 1, further comprising:
sending a product communication to the user device within an alert period.

9. The method of claim 1, further comprising:
sending a warranty claim status to a user device upon receiving a one-click input.

10. The method of claim 1, further comprising:
creating a product report for a commerce chain member.

11. The method of claim 1, further comprising:
sending a recall notice to a user device upon initiation by a commerce chain member.

12. The method of claim 1, further comprising:
providing a product manual for a consumer product to a user device.

13. A tangible machine-readable medium having a set of instructions detailing a method stored thereon that when executed by one or more processors cause the one or more processors to perform the method, the method comprising:
registering with a user device a product purchase by a user of a consumer product with a consumer-centric product tracking system separated from a commerce chain to create a purchase association between the user and the consumer product; and
downloading a peripheral product data set to a user device based on the purchase association.

14. The tangible machine-readable medium of claim 13, wherein the method further comprises:
scanning a purchase receipt with the user device to register the product purchase.

15. The tangible machine-readable medium of claim 13, wherein the method further comprises:
receiving a user input of a product purchase into a user device to register the product purchase.

16. The tangible machine-readable medium of claim 13, wherein the method further comprises:
executing a thin client application to display the peripheral product data set.

17. The tangible machine-readable medium of claim 13, wherein the method further comprises:
registering a warranty renewal with a commerce chain member.

18. The tangible machine-readable medium of claim 13, wherein the method further comprises:
displaying a warranty comparison for the consumer product to a user upon receiving a one-click input.

19. A consumer-centric product tracking server, comprising:
a network interface that receives a first purchase notification of a first product purchase by a user of a first consumer product of a first commerce chain and a second purchase notification of a second product purchase by the user of a second consumer product of a second commerce chain; and
a database interface that interacts with a user database that maintains a first purchase association between the user and the first consumer product and a first peripheral product data set and a second purchase association between the user and the second consumer product and a second peripheral product data set.

20. The network service access client of claim 19, wherein the first peripheral product data set is at least one of a product manual, a proof of purchase, a product related communication, and a warranty agreement.
